(19) United States
(12) Patent Application Publication
(10) Pub. No.: US 2014/0223746 A1
(43) Pub. Date: Aug. 14, 2014

(54) PORTABLE BATTERY OPERATED PIPE CUTTER

(71) Applicant: K-RAIN MANUFACTURING CORP., RIVIERA BEACH, FL (US)

(72) Inventors: Eric Davis SCHWARTZ, Riviera Beach, FL (US); Frederick A. HALL, Riviera Beach, FL (US)

(73) Assignee: K-RAIN MANUFACTURING CORP., RIVIERA BEACH, FL (US)

(21) Appl. No.: 14/226,640

(22) Filed: Mar. 26, 2014

Related U.S. Application Data
(62) Division of application No. 12/694,093, filed on Jan. 26, 2010.
(60) Provisional application No. 61/147,439, filed on Jan. 26, 2009.

(51) Int. Cl. B23D 21/10

(52) U.S. Cl. CPC B23D 21/10
USPC 30/92

(57) ABSTRACT

A portable pipe cutter assembly in accordance with an embodiment of the present application includes a cutting blade that is mounted to move up and down in a vertical plane to cut a pipe. The assembly may include a cradle that supports a lower part of the pipe to prevent deformation as it is being cut. The cutting blade is preferably moved by a battery operated motor.

### CROSS-REFERENCE TO RELATED APPLICATION

This application is based on and claims priority to U.S. Provisional Patent Application Ser. No. 61/147,439, filed on Jan. 26, 2009 and entitled PORTABLE BATTERY OPERATED PIPE CUTTER, the entire contents of which are hereby incorporated by reference.

### BACKGROUND

1. Field of the Disclosure

The present disclosure relates to a portable pipe cutter assembly. In particular, the present disclosure relates to a battery powered portable pipe cutter assembly that avoids pipe deformation and saves labor.

2. Related Art

Portable tools for cutting pipes, such as polyvinyl chloride (“PVC”) pipes, are known. In addition to hand-operated cutting devices, powered pipe cutting tools have been developed to reduce the labor associated with pipe cutting.

One known pipe cutter includes cutting wheels that rotate to cut pipes. Another pipe cutter is known that is configured as ratchet scissors, and includes a movable handle unit and a stationary handle unit, whereby the movable handle unit moves back and forth about a pivot point, and a pivotable blade cuts a pipe.

Yet another known pipe cutter includes a reciprocating saw blade with an attaching assembly. This cutter includes a pipe holder block with pipe receiving slot and a saw blade slot and during cutting of a pipe, the saw blade moves into the pipe receiving slot, engages the pipe and cuts it.

Other prior art devices are also known in various powered and manual configurations that are operable to cut pipes.

Although pipe cutting devices in the prior art do allow for cutting of pipes, all suffer from various drawbacks. A common drawback is that the devices result in either deformation of the pipe that is cut and/or require substantial effort by the user to operate. Pipe cutters that pivot, for example, often provide only fair or even poor quality cuts for assembling cut pipes into fittings. Further, prior art ratchet tools require a user to use two hands to release the pipe after cutting, which requires more time and effort to cut pipes.

Some known and prior art pipe cutters push the pipe away from the cutter as the pipe is cut, which can cause a danger to the user.

Accordingly, it would be beneficial to provide a portable pipe cutter assembly that avoids the above-identified shortcomings.

### SUMMARY

It is an object of the present application to provide a safe portable pipe cutter, or cutting device, that avoids deformation of pipes and also reduces time and labor involved on the part of the user to cut a pipe.

In accordance with one embodiment, a portable handheld battery operated plastic pipe cutter assembly includes one blade that will move vertically up and down with a motor that is preferably run from a rechargeable battery.

More particularly and in an embodiment, a portable battery powered pipe cutter assembly is disclosed for cutting a pipe. In a preferred embodiment, the assembly includes a motor with a rotor that rotates about a first axis when power is provided to the motor. A gearbox is connected to the motor, wherein the gearbox includes at least one gear that rotates about a second axis that is perpendicular to the first axis. Further, a cutting blade is provided that is operatively coupled to the gearbox, and the cutting blade moves in a vertical plane when power is supplied to the motor. Power is provided by a battery, which is preferably rechargeable. Moreover, the pipe cutter assembly includes a cradle portion coupled to the gearbox and the motor, wherein cradle portion is operable to receive the pipe and further wherein the cutting blade is operable to move along the vertical plane within the cradle and cut the pipe.

In a second embodiment, two blades are operated in a scissors-type motion.

In a third embodiment, two blades are moved vertically up and down.

In another embodiment, the portable pipe cutter includes a motor including a rotor that rotates about a first axis when power is supplied to the motor, a power supply electrically connected to the motor to supply the power to the motor and a cutting blade operatively coupled to the rotor wherein the cutting blade oscillates in a vertical plane as a function of the rotation of the rotor.

Other features and advantages of the present invention will become apparent from the following description of the invention, which refers to the accompanying drawings.

### BRIEF DESCRIPTION OF THE DRAWINGS

FIG. 1 shows a side view of a portable pipe cutter assembly in accordance with an embodiment of the present application, with a single blade, belt clip, rechargeable battery, blade, down button, and curve to stop PVC pipe deformation.

FIG. 2 shows a cross sectional view of the cutter assembly of FIG. 1 illustrating the blade and a gearbox and motor.

FIG. 3 shows a cross section view of the cutter assembly of FIG. 1 illustrating the lower part thereof.

FIG. 4A illustrates an exemplary embodiment of the blade, motor and gearbox of the cutter assembly of FIG. 1.

FIG. 4B illustrates a top view of the blade and the gears of the cutter assembly of FIG. 1.

FIGS. 5A and 5B illustrate exemplary embodiments of the pipe cutter assembly, including the use of screw holes formed in the blade or blade housing of the cutter assembly of FIG. 1.

FIG. 6 shows a cross sectional view of the cutter assembly of FIG. 1 with the blade cutting a pipe.

FIGS. 7A and 7B illustrate more detailed views of a power switch button of the cutter assembly of FIG. 1.

FIG. 8 shows an exemplary embodiment of a rechargeable battery preferably usable with the cutter assembly of the present application.

FIG. 9 shows a side view of the blade of the cutter assembly of FIG. 1.

FIGS. 10A and 10B show more detailed side views of the lower cradle and blade area of the cutter assembly of FIG. 1.

FIG. 11 shows a sectional view of the cradle and blade area of a cutter utilizing a non-curved lower part.

FIGS. 12A-12C show top, side and bottom views, respectively, of the cradle of the cutter assembly of FIG. 1.

FIG. 13 shows a cross sectional view of an alternative embodiment of a portable pipe cutter assembly in accordance with the present application wherein two blades travel in a scissors motion.

FIG. 14 shows cross sectional view of another embodiment of a portable pipe cutter assembly in accordance with the present application with two blades traveling in a vertical motion.

FIGS. 15A-15B illustrates side and front views, respectively, of the blade guards of a portable pipe cutter assembly in accordance with an embodiment of the present application.

FIG. 16A illustrates interaction of the scissor blades of FIG. 13 with a gear to move the blades into a closed position.

FIG. 16B illustrates interaction of the scissor blades of FIG. 13 with a gear to move the blades into an open position.

FIG. 17 is a more detailed view of the relationship of the scissor blades, the gear and motor of the portable pipe cutter of FIG. 13.

FIG. 18 illustrates an alternative embodiment of a portable pipe cutter assembly in accordance with the present application.

FIG. 19 illustrates a more detailed view of the portable pipe cutter assembly of FIG. 18.

FIG. 20A illustrates a bearing mounted on a motor plate of a rotor in the portable pipe cutter of FIG. 18.

FIG. 20B illustrates the relative upward and downward motion of the bearing relative to a center axis of the motor plate of the portable pipe cutter of FIG. 18.

### DETAILED DESCRIPTION OF THE EMBODIMENTS

In accordance with one embodiment, a portable handheld battery operated pipe cutter assembly includes one blade that will move vertically up and down, with a motor that is preferably run from a rechargeable battery.

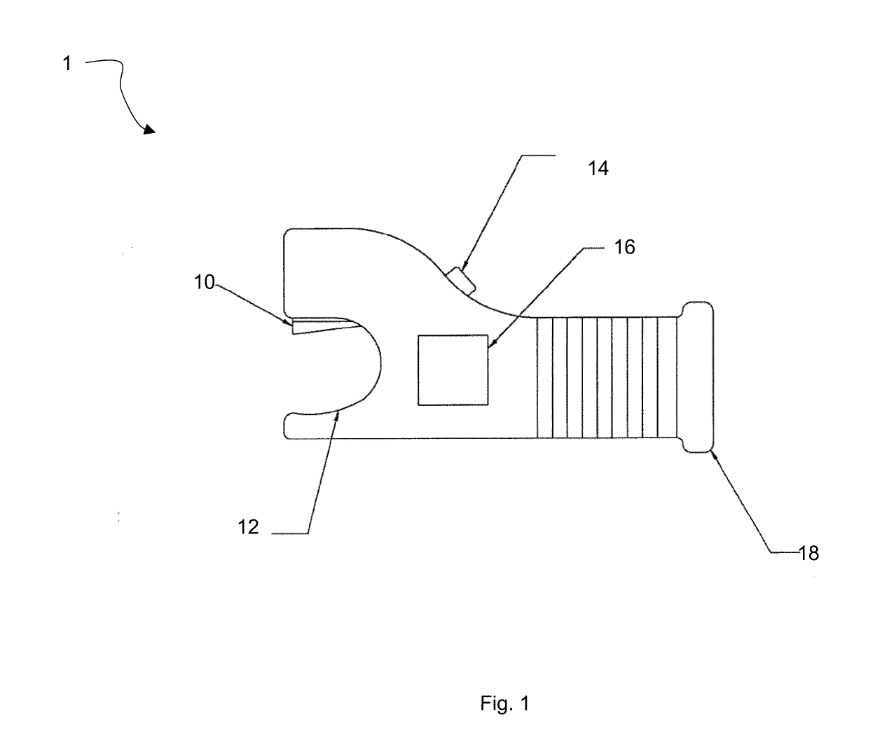

FIG. 1 illustrates a portable pipe cutter assembly 1 in accordance with an embodiment of the present application. In this embodiment, a bottom part, or cradle 12, of cutter assembly 1 includes a curved surface to help to stop deformation of a plastic pipe 100, for example, while being cut. Cradle 12 properly accommodates a pipe when it is placed in cutter assembly 1. In a preferred embodiment, cradle 12 has a U-shaped top surface. This shape provides support to the pipe as blade 10 is cutting into it.

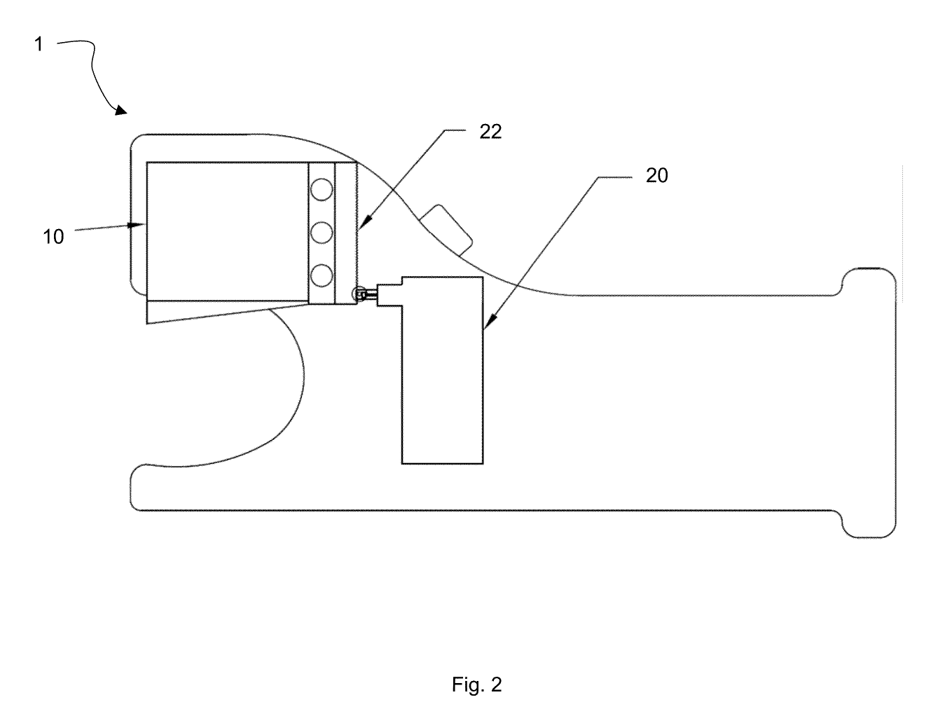

In a preferred embodiment and as illustrated in FIG. 2, an electric motor is connected to a gearbox, and motor and gearbox 20 are connected to blade 10. The gearbox changes the rotating axis of the motor from horizontal to vertical. As a result, blade 10 is movable vertically, that is up and down, to cut pipe 100.

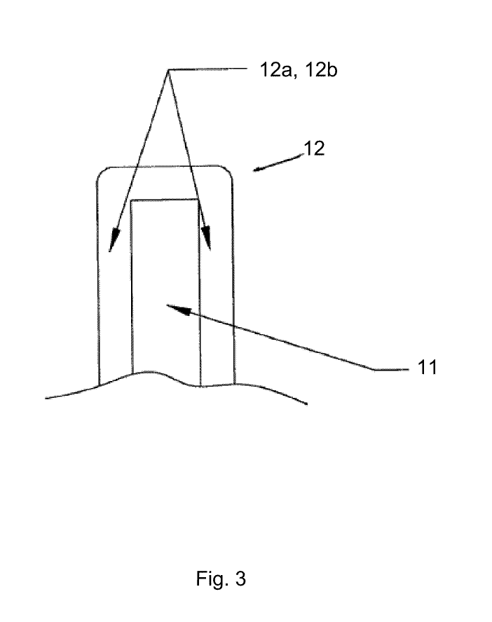

FIG. 3 shows a cross section view of cutter assembly 1 of FIG. 1 illustrating the lower part thereof. As shown in FIG. 3, the shape of cradle 12 includes opening 11, and distributes force evenly on both arms 12a, 12b of the U-shape to reduce the load absorbed by pipe 100 from the force of blade 10 on the pipe. This reduces the chance of deformation of the pipe as well.

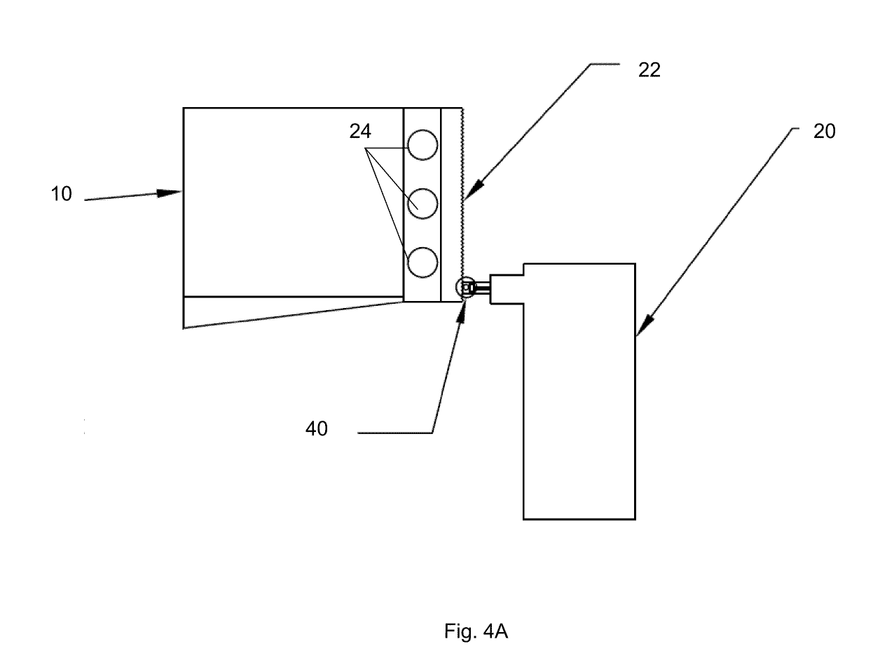

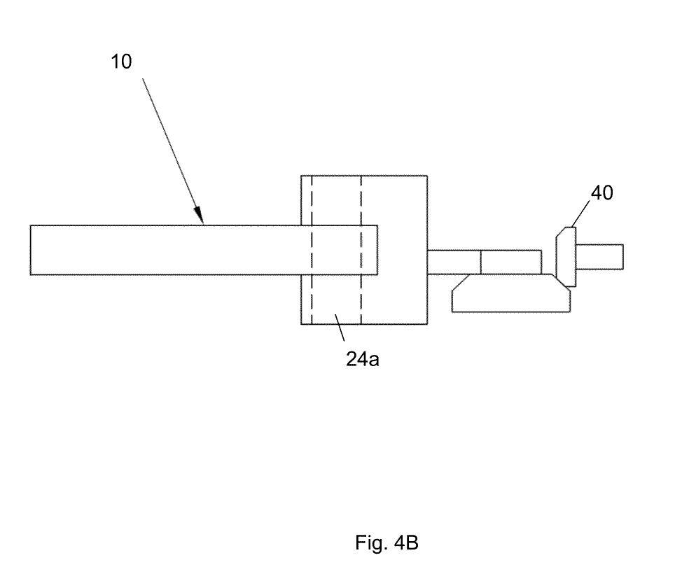

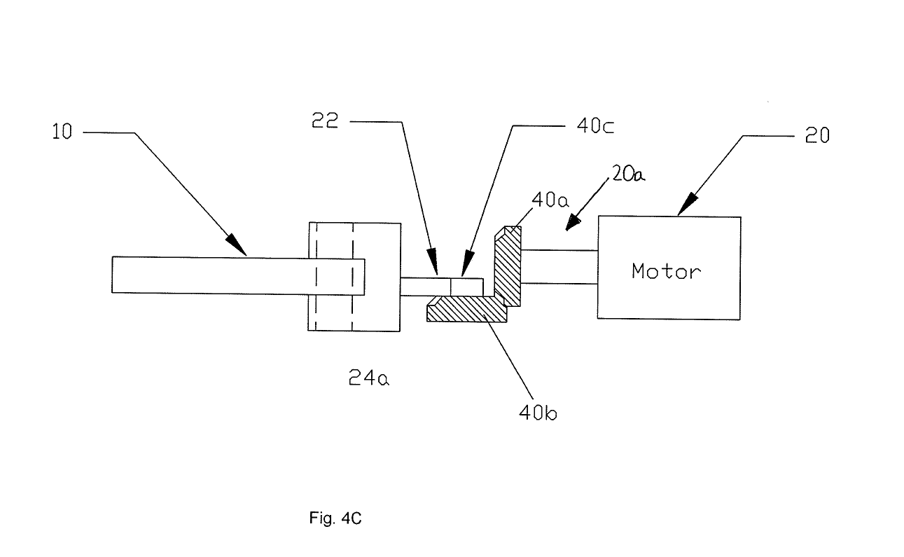

FIGS. 4A and 4B illustrate another exemplary embodiment of the blade and motor and gearbox of cutter assembly 1 of FIG. 1. More specifically, as can be seen in FIG. 4A, for example, motor and gearbox 20 rotate a pinion gear 40, which engages a rack gear 22 to move blade 10 up and down in a vertical plane. Blade 10 is preferably screwed in three places to rack gear 22. Screw pins 24 provide more strength compared to other fastening techniques, such as welding, for example, which weakens the metal. Thus, screwing blade 10 generally causes less stress on the metal. Screw pins 24 also allow for easy replacement of blade 10 if it breaks or becomes dull.

In a preferred embodiment, a gear ratio provided in the gearbox is set such that the gears will take a high torque. This is provided due to the high rotational speed of the motor, which, if the gear ratio was not changed would create a low torque and not be adequate enough to move the blade to cut through the pipe. In the gear box, the gears in contact with the motor have a small tooth design which meshes with a large tooth design to provide high torque. This high torque is what the drives the blade to cut through the pipe. With high torque, the gear box is reducing the speed of the large gear and thereby providing more force for the output of the gearbox to the blade.

FIG. 4B illustrates a top view of the blade and the gears of cutter assembly 1 of FIG. 1. As shown in FIG. 4B, screw holes 24a are provided in blade 10, and pinion gear 40 is coupled to and rotated by motor and gearbox 20.

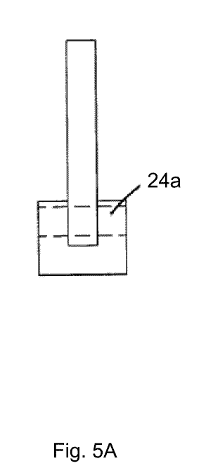

FIGS. 5A and 5B illustrate the use of screw holes 24a formed in mounting bracket 10c of blade 10, and enable blade 10 to move in a vertical plane. By moving blade 10 in a vertical plane, that is up and down, only when cutting pipe 100, superior cutting results are obtained. For example, prior art ratchet cutters typically pivot off of a point inward and result in a gauged cut that is not straight. Utilizing a vertically moving blade, such as blade 10 of cutter assembly 1 of the present application, there is no need to pivot, which will result in a better cut for assembling the pipes in fittings, for example.

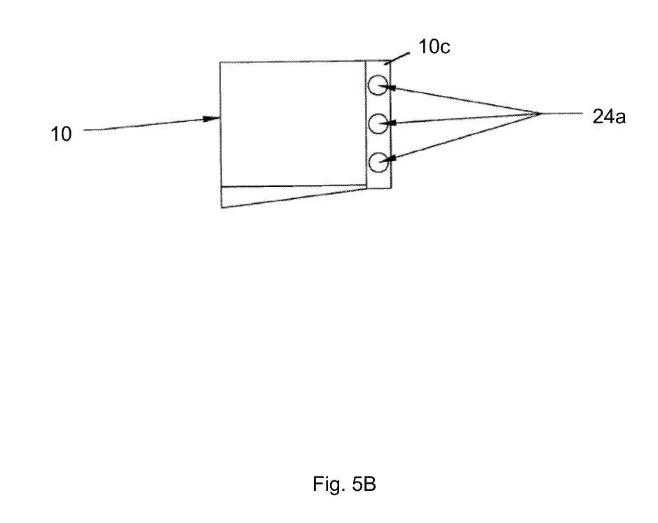

FIG. 6 illustrates the up and down motion of blade 10 in cutting pipe 100, for example. In the example shown in FIG. 6, blade 10 is coupled to rack gear 22, and operable to move in a vertical plane to cut pipe 100.

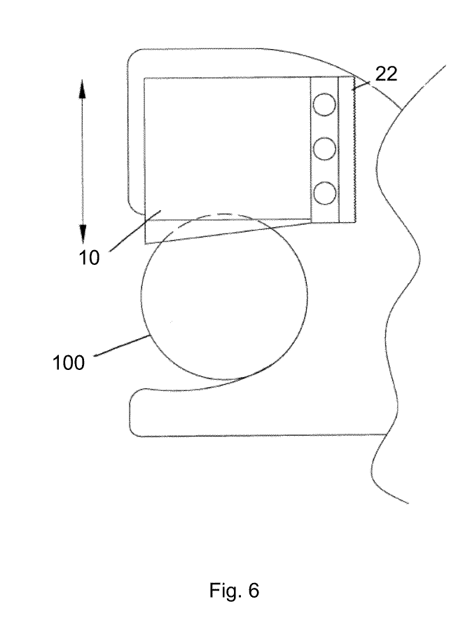

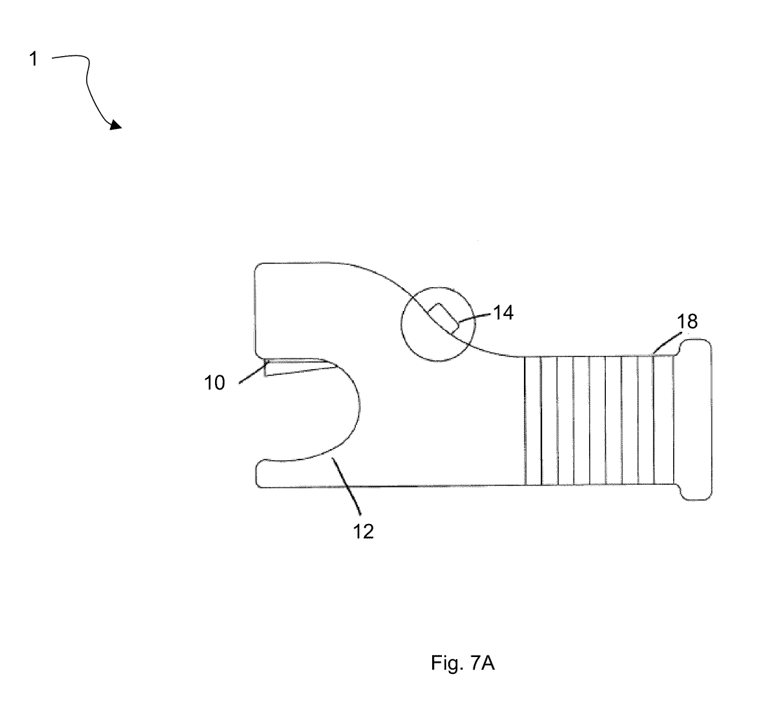

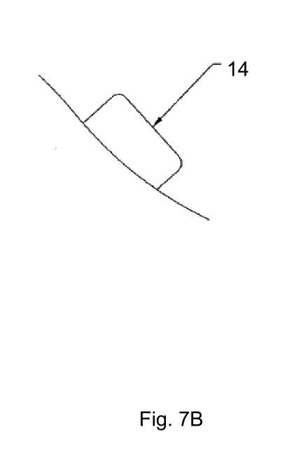

Referring now to FIGS. 7A and 7B, cutter assembly 1 preferably includes a down button, or switch 14, that is preferably pressed by the user and held down to move blade 10 down to cut pipe 100. Releasing button 14 will automatically retract blade 10. This feature provides added safety for users and eliminates the possibility of blade 10 being left half way down and increasing the risk of cutting the user.

Furthermore, utilizing button 14 of the present application, cutter assembly 1 can be operated entirely with one hand. In contrast, prior art ratchet tools require a user to use two hands to release the pipe after cutting. As a result, users will save substantial time using cutter assembly 1 of the present application as compared to using prior art ratchet tools while cutting and installing multiple pipes or pipe sections. Thus, cutter assembly 1 of the present application provides a distinct advantage over ratchet tools.

In a preferred embodiment, cutter assembly 1 utilizes a rechargeable battery 18 to power motor and gearbox 20. As a result, the user is able to re-charge cutter assembly 1 overnight, or between jobs, to maintain maximum performance. Cutter assembly 1 preferably will be operable by rechargeable battery 18 for several hours.

FIG. 8 illustrates an exemplary embodiment including rechargeable battery 18. Battery 18 is preferably suitable for quick recharges. In a preferred embodiment, battery charging options include an AC adapter which allows for recharging using an AC power supply, such as a wall outlet, and/or a DC accessory for field charging battery 18 in the even that an AC power source is not available.

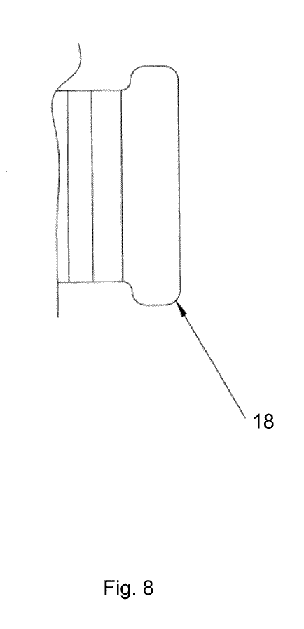

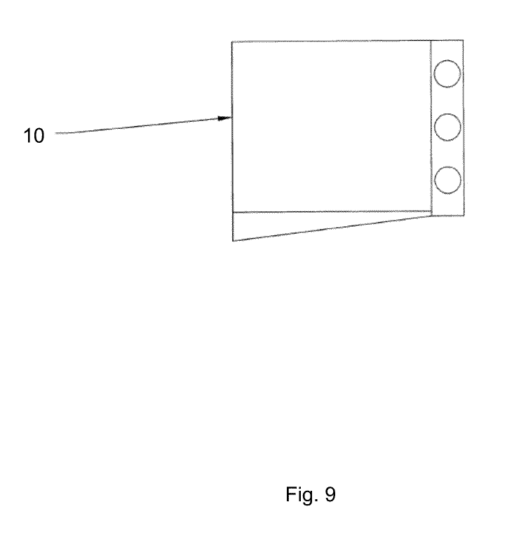

Referring now to FIG. 9, the cutter side of blade 10 is preferably angled down and away from the mounting side such that the blade acts like a slicer to force pipe 100 into cradle 12 of cutter assembly 1. The angle on blade 10 will also take some pressure of force off of the pipe and will further help with cutting. As noted above, some prior art pipe cutters push a pipe away from the cutter as the pipe being is cut, which presents a danger to the user. With cutter assembly 1 of the present application blade 10 in FIG. 9, for example, pulls pipe 100 into cradle 12, thereby providing a safe environment for the user.

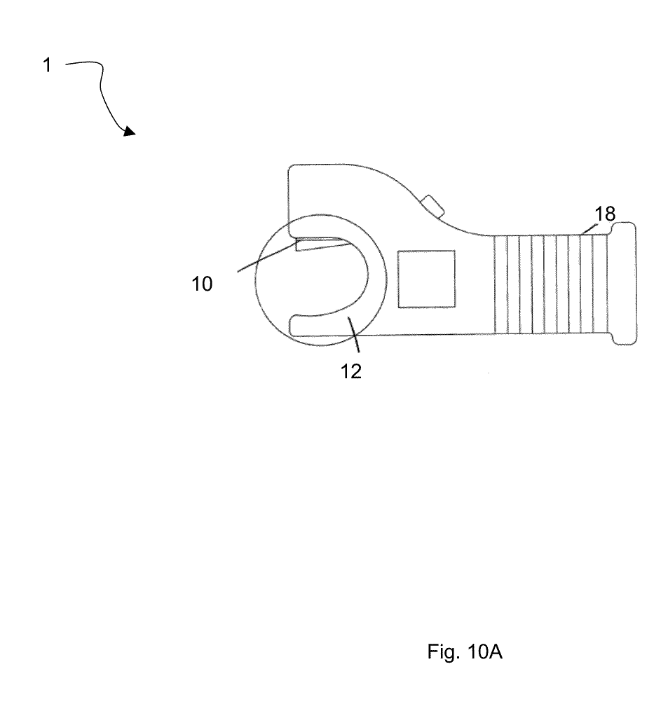

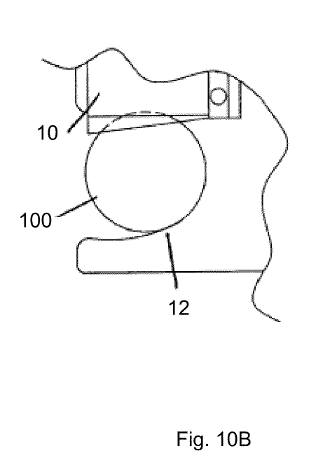

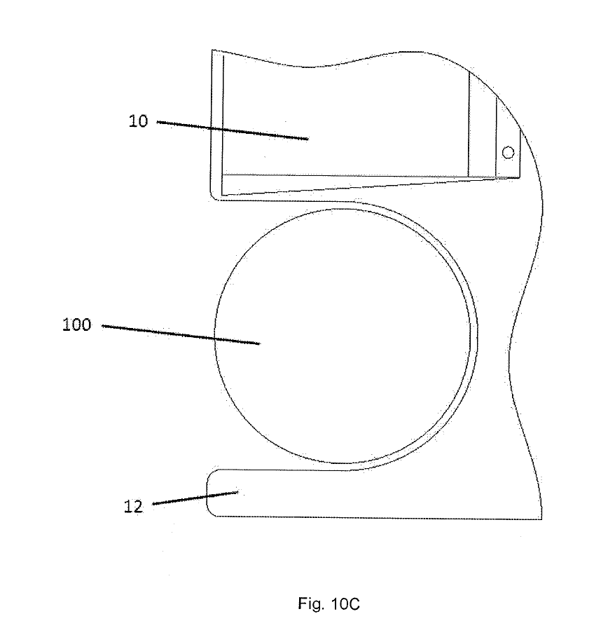

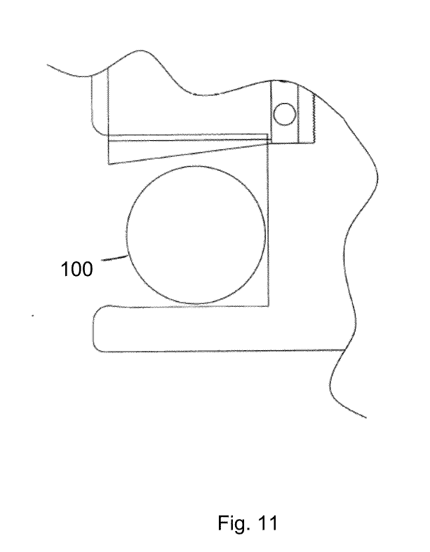

As noted above, cradle 12 is preferably curved to stop deformation of pipe 100. Cradle 12 will preferably continue up the side in the vertical direction as shown in FIGS. 10A and 10B. By doing this, the user supports pipe 100 on more of its surface, and thus, deformation is limited, when compared to the use of a 90° corner, such as that illustrated in FIG. 11. As can be seen in FIG. 11, for example, the pipe is not fully supported since blade 10 pushes the pipe into the 90° corner. In contrast, as can be seen in FIG. 10B, when cutter assembly 1 of the present application is used, pipe 100 is fully supported. This will help pipe 100 stay in its original round shape and make it easier for the pipe to be inserted into a coupling.

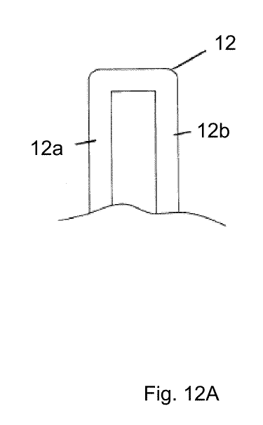

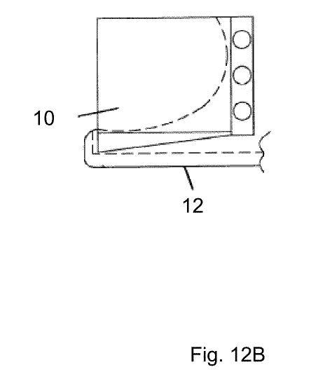

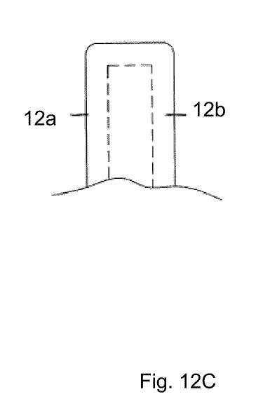

As shown in FIG. 12A, when blade 10 is completely closed, the U-shape of cradle 12 allows the blade to be completely sealed or closed off. This provides safety in contrast to other known pipe cutters that keep a blade at least partially exposed, even when closed. As can be seen in FIG. 12B, cutter assembly 1 of the present application provides blade 10 to be sealed off by blade guards 12a, 12b and not exposed in the closed or down position. The U-shape of cradle 12, such as shown in FIGS. 3 and 12, also provides extra support of the pipe, and allows the blade to submerge into the cradle and not be exposed while in a closed or down position.

As shown in FIG. 12C, the open part of the U-shape does not go all the way through cradle 12. Thus, there is a plastic bottom surface that closes the blade's cutting edge from being exposed in the closed or down position.

In a preferred embodiment, cutter assembly 1 is waterproof or water-resistant for both safety and to prevent tool damage. This will also allow assembly 1 to be used on existing installations located in wet environments or uncut pipes filled with water that would escape and spill onto the tool.

In a preferred embodiment, cutter assembly 1 also includes an external attachment device 16 to allow for hands free storage between uses. Device 16 in FIG. 1 is preferably a belt clip, but may be any suitable device.

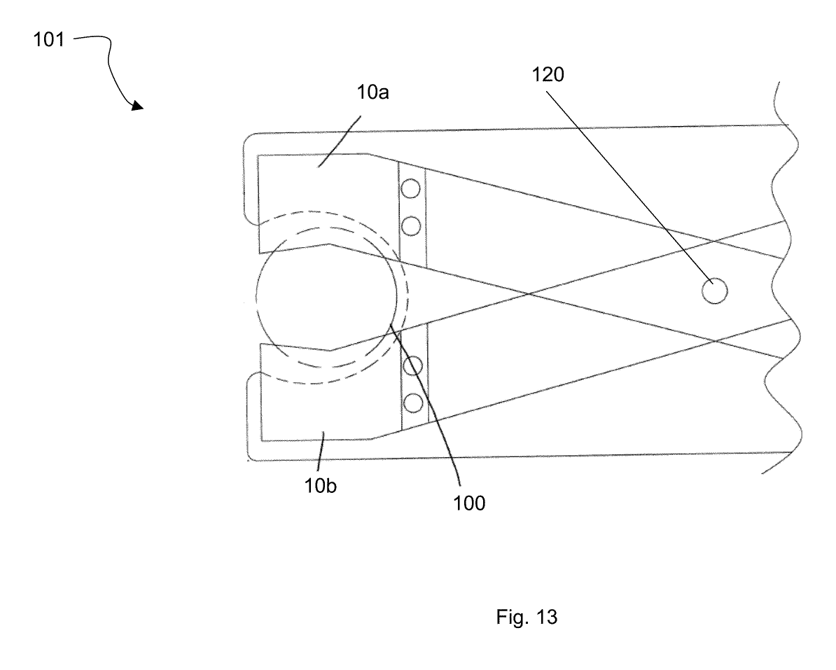

FIG. 13 illustrates a portable pipe cutter assembly 101 that includes two blades 10a, 10b. Utilizing two blades reduces the travel distance of a single blade through pipe 100 by half, and results in reduced blade wedging. A double blade tool also exerts equal forces on both sides of pipe 100, eliminating any unintended torque angle or veering. In addition, a double blade cutter assembly will eliminate the need for pipe support reinforcement and prevents pipe deformation. The force is shared between two blades 10a, 10b of the double blade cutter assembly 101 and is applied evenly to pipe 100 from both directions. A double blade cutter assembly eliminates supporting forces exerted on the opposing side of the pipe that differ from the cutting forces.

In the double blade configuration, the motor and gearbox, for example, are preferably located behind blades 10a, 10b to reduce overall tool size and aesthetic unevenness. The motor and gearbox demands for a single blade cutting tool require them to not only apply adequate force to cut, but additional force for “blade wedging”. The motor and gearbox demands for a double blade cutting tool eliminate the need for the additional force to overcome blade wedging. In FIG. 13, blades 10a, 10b are connected to each other in a scissors-type arrangement at pivot 120 such that the motor and gearbox will move the blades together, or one blade toward the other blade.

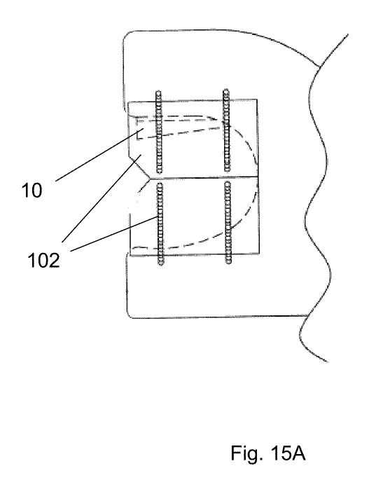

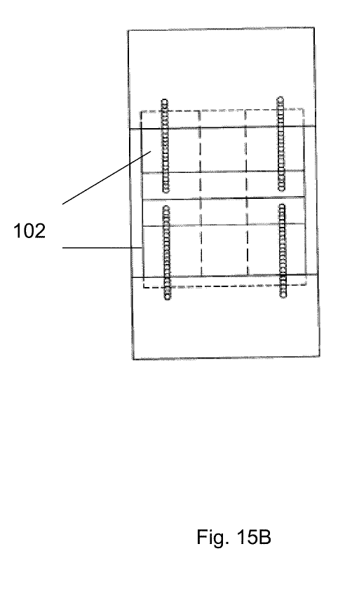

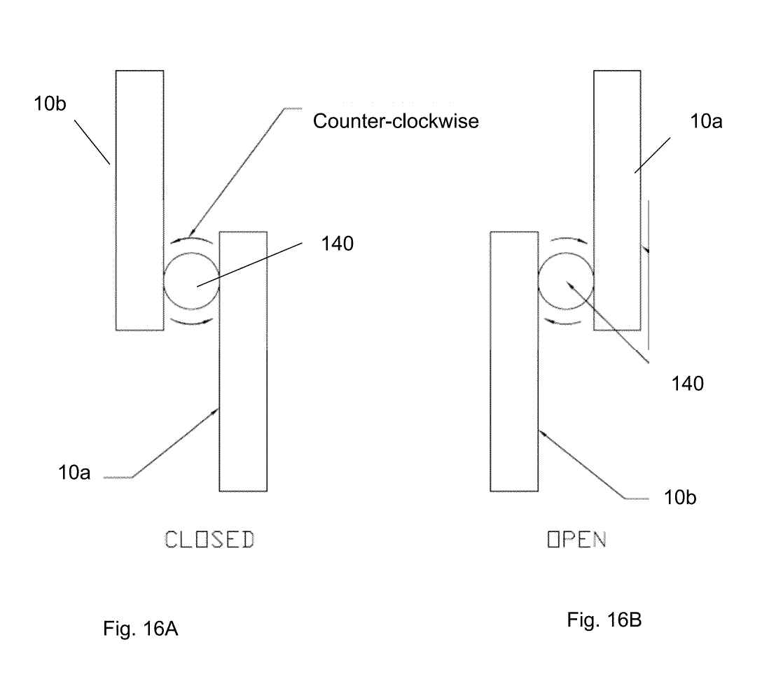

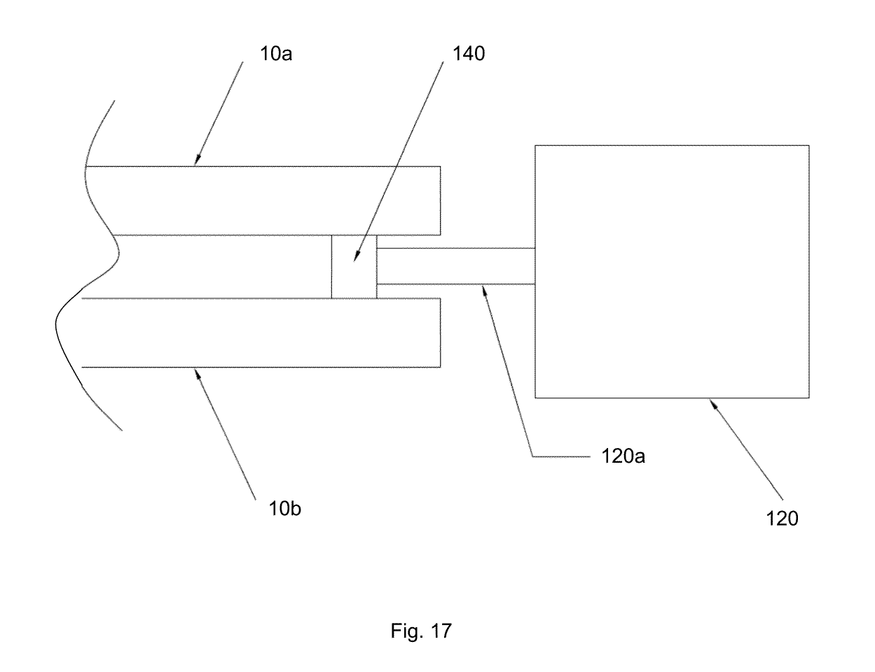

FIGS. 16-17 illustrate a single motor 120 (see FIG. 17, for example) which is in line with the scissor blades 10a, 10b to allow the pipe cutter to use a planetary gear set 120a which will reduce the area needed for the mechanism. This arrangement allows the pipe cutter 101 to be smaller in size and lighter and to use a smaller motor to save on costs. The location of the ends of scissor blades 10a, 10b allows the motor 120 to only have one gear 140 which drives both scissor blades 10a, 10b at the same time using the same force. FIG. 16A illustrates the gear 140 rotating in a counter clockwise direction to move the scissor blades 10a, 10b into a closed position to cut pipe. FIG. 16B illustrates the gear 140 rotating in a clockwise direction to move the blades 10a, 10 b into an open position. FIG. 17 illustrates the relative position of the motor 120, gear 140 and the ends of the blades 10a, 10b. The arrangements illustrated in FIGS. 16-17 allow the motor 120 to move the scissor blades 10a, 10b at equal speed with an equal and force.

Another option for the gear drive is to use a planetary gear box from the motor 120 to drive a lead screw, which is part of a mechanical jack system. This system would work in a manner similar to that illustrated FIGS. 16A, 16B. Rotating the lead screw clockwise would separate the ends of the blades 10a, 10b into an open position. Rotating the lead screw in a counter clockwise direction would bring then ends of the blades 10a, 10b together into a closed position. Using the lead screw/jack device would allow cutting of the pipe without the need for extra torque. As a result there is no need for the high gear ratio between the motor 120 and the lead screw and a lower power motor can be used, if desired.

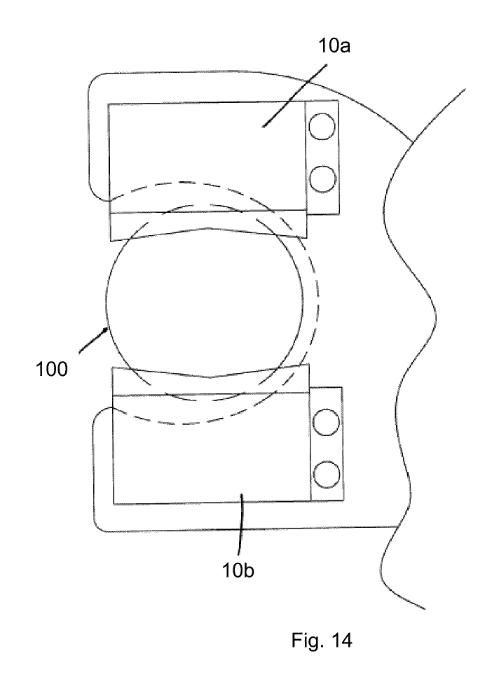

Alternatively, and as illustrated in FIG. 14, blades 10a, 10b are separate from each other and movable down and up, respectively, toward each other to cut pipe 100.

In all embodiments, a protected or concealed switch (button/trigger), such as button 14, ensures safety and prevents accidental operation during non-use. Activation of assembly 1, 101 will require continuous pressure/force from user. When pressure/force to button 14 is released the tool will automatically reverse to the full open position. This ensures quick return of blade or blades during accidental or unintended use of the tool.

FIG. 15A illustrates a side view of how blade guards 102 cooperate to enclose blade 10. FIG. 15B illustrates a front view of how the blade guards cooperate to enclose the blade 10.

Thus, as shown and described herein, an improved portable pipe cutter apparatus is provided that reduces the amount of labor and time previously required for cutting a pipe, such as a PVC pipe. Furthermore, the portable pipe cutter apparatus prevents a pipe from being deformed when force from the blade(s) are exerted thereon. Moreover, by providing a fully retracted blade, while in a closed position, and by pulling a pipe into the cradle portion 12, a safe cutter assembly 1 is provided that is superior to known, prior art cutters.

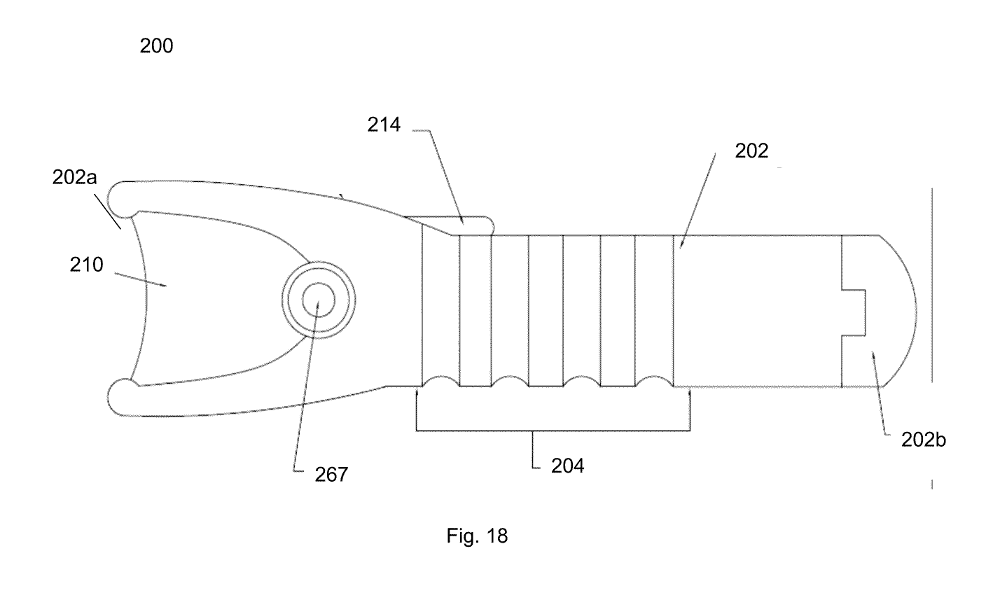

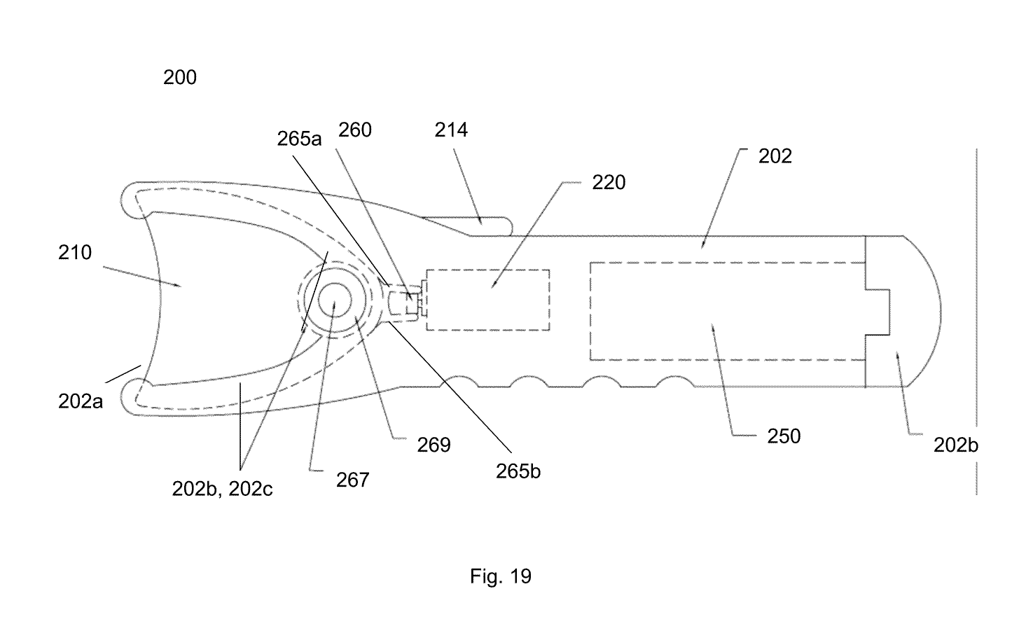

FIG. 18 illustrates an alternative embodiment of a portable pipe cutter 200. In the embodiment of FIG. 18, the blade 210 oscillates at a relatively high speed to cut through the pipe. The housing 202 is elongated and includes a plurality of finger grips 204 to allow for easy gripping in one hand. The blade 210 is mounted in the u-shaped opening 202a formed at a first end of the housing. A battery cap 202b is positioned on an opposite end of the housing 202 to allow for installation and removal of a battery 250(see FIG. 19, for example).

As can be seen in FIG. 19, a motor 220 is mounted in the housing 202. The battery 250 is provided to provide power to the motor 220. The motor 220 is turned on and off utilizing the switch 214. In a preferred embodiment, when pressure is applied to the switch 214, the battery 250 provides power to the motor 220 and the rotor of the motor rotates. When pressure is removed, the battery is disconnected from the motor and the rotor stops rotating.

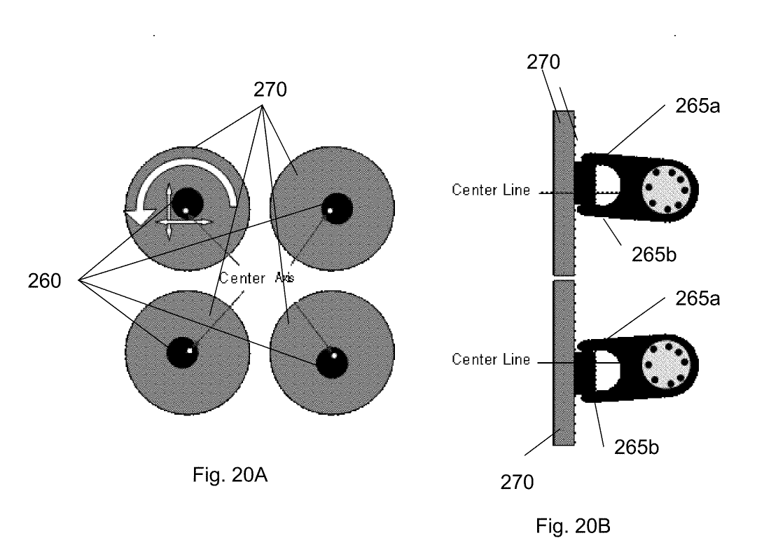

The rotor of the motor 220 is connected to a motor disk 270, which is further connected to a bearing 260. More specifically, as illustrated in FIGS. 20A-20B, for example, the motor disk 270 is provided at the end of the rotor and a bearing 260 is connected to the disc at a position offset from a center axis of the disk. The bearing 260 is seated in a first end of the frame 265 between a first set of legs 265a, 265b. The blade 210 is secured to an opposite end of the frame 265 via the screw 267 and the washer 269, preferably between a second set of legs 202b, 202c of the housing 202, and extends into the open portion of the opening 202a of the housing 202.

The screw 267 and washer 269 allow the blade 210 to be removably mounted on the frame 265 such that the blade can be easily replaced, if desired. In an alternative arrangement, screw 267 and washer 269 can be replaced by a wing nut or like device as known by those skilled in the art. The wing nut or like device eliminates a need for additional tools to provide a blade 210 and provides for, for example, easier removal and/or replacement of blade 210 by a user's hand.

As shown in FIG. 19, cutting blade 210 is preferably formed in a concave shape that provides for improved pipe cutting. The concave shape improves upon straight blades found in the prior art by accommodating pipes and preventing a pipe from sliding or straying during a cutting process. The concave shape of cutting blade 210 maintains the center of the pipe in the center of cutting blade 210 during cutting, and prevents the pipe from “walking” toward an end of the blade. Thus, the pipe is maintained at the deepest part of cutting blade 210, which maximizes the blade's 210 ability to cut the pipe.

FIG. 20A shows the position of the offset bearing 260 as the motor disk 270 rotates with the rotor. As the rotor rotates, the bearing 260 moves up relative to the center axis of the disk, as can be seen in the top of FIG. 20B and the bearing 260 moves down relative to the center axis as shown in the bottom of FIG. 20B. The bearing pushes against the legs 265a, 265b of the frame 265 as it moves up and down to oscillate the frame 265 and blade 210. The offset connection between the motor disk 270 and the bearing 260 results in vertical oscillation of the frame 265, and blade 210. As a result, the blade 210 oscillates up and down. In an example embodiment, the rotor rotates at a speed sufficient to provide oscillation of the blade 210 at a rate of between 20,000 to 25,000 cycles per second. This high-speed oscillation allows the blade 210 to easily cut a pipe. It is noted that the vertical oscillation of the frame 265 and blade 210 is over a short distance, as can be seen in FIGS. 20A, 20B, however, the high speed provides for excellent cutting results.

Although the present invention has been described in relation to particular embodiments thereof, many other variations and modifications and other uses will become apparent to those skilled in the art.

1-26. (canceled)

27. A portable pipe cutter assembly, comprising:
a motor including a rotor that rotates about a first axis when power is supplied to the motor;
a power supply electrically connected to the motor to supply the power to the motor;
a gearbox including at least one gear that rotates about a second axis, the motor operatively connected to the at least one gear;
a first cutting blade operatively coupled to the gearbox, wherein the cutting blade moves in a plane perpendicular to the second axis as a function of the rotation of the at least one gear;
a second cutting blade operatively coupled to the gearbox, wherein the second cutting blade moves in a plane perpendicular to the second axis when power is supplied to the motor, the first cutting blade and the second cutting blade move in opposite directions along the plane to cut the pipe; and
a cradle portion coupled to the gearbox and the motor, wherein the cradle portion is configured and operable to receive a pipe and the first cutting blade and second cutting blade move in the plane within the cradle portion to cut the pipe.

28. The pipe cutter assembly of claim 27, further comprising:
a pinion gear operably connected to the at least one gear of the gearbox to rotate about the second axis;
a first rack gear engaged by the pinion gear and coupled to the first cutting blade such that rotation of the pinion gear moves the first cutting blade in the plane in a first direction;
a second rack gear engaged by the pinion gear and coupled to the second cutting blade such that rotation of the pinion gear moves the second cutting blade in the plane in a second direction, opposite the first direction.

29. The pipe cutter assembly of claim 27, wherein the cradle portion includes a U-shaped portion having two sides that cover two sides of the first cutting blade and the second cutting blade cutting blade as the first and second cutting blades move within the cradle portion.

30. The pipe cutter assembly of claim 27, wherein the cradle portion includes a curved portion that accommodates the pipe and further wherein the curved portion prevents the pipe from deforming as the cutting blade cuts the pipe.

31. The pipe cutter assembly of claim 27, wherein the first and second cutting blades apply force to the pipe to cut the pipe, and the cradle portion distributes the force of the cutting blades evenly and reduces load absorbed by the pipe caused by the cutting blades on the pipe.

32. The pipe cutter assembly of claim 27, wherein a gear ratio is provided in the gearbox for the at least one gear in the gearbox to rotate at a speed that is slower than a speed of rotation of the rotor.

33. The pipe cutter assembly of claim 32, wherein the rotation of the rotor causes a first force, and the rotation of the at least one gear in the gearbox causes a second force, wherein the second force is greater than the first force as a function of the gear ratio.

34. The pipe cutter assembly of claim 33, further comprising:
a first blade housing provided in the cradle portion that is operable to fully receive the first cutting blade when no power is provided to the motor; and
a second blade housing provided in the cradle portion that is operable to fully receive the second cutting blade when no power is provided to the motor

35. The pipe cutter assembly of claim 27, further comprising an actuator that when actuated causes power to be supplied from the power supply to the motor.

36. The pipe cutter assembly of claim 35, wherein the actuator is a button, and the power is supplied from the power supply to the motor only when the button is depressed.

37. The pipe cutter assembly of claim 27, further comprising:
a first arm and a second arm, each of the first arm and second arm pivotably coupled to the first and second cutting blades, respectively; and
supports for the first and second arms operatively coupled to the at least one gear of the gearbox such that the first cutting blade and the second cutting blade move in the opposite directions along the plane to cut the pipe when the at least one gear rotates.

38. The pipe cutter assembly of claim 27, further comprising a hands-free storage element.

39. The pipe cutter assembly of claim 27, wherein the power supply is a battery.

40. The pipe cutter assembly of claim 39, wherein the battery is rechargeable.

41. A portable pipe cutter assembly, comprising:
a motor including a rotor that rotates about a first axis when power is supplied to the motor;
a power supply electrically connected to the motor to supply the power to the motor; and
a cutting blade operatively coupled to the rotor wherein the cutting blade oscillates in a plane as a function of the rotation of the rotor.

42. The portable pipe cutter of claim 41, further comprising:
a motor disk mounted on a free end of the rotor to rotate with the rotor;
a bearing connected to the motor disk to rotate with the motor disk; and
a frame including a recess formed at a first end thereof to receive the bearing and to which the cutting blade is secured, wherein the bearing is connected to the motor disk at a point parallel to the first axis of the rotor and offset from a central axis of the motor disk, such that the frame and cutting blade oscillates in the vertical plane as the motor disk rotates with the rotor.

43. The portable pipe cutter of claim 42, wherein the motor rotates the rotor such that the frame and cutting blade oscillate at a rate of between 20,000 cycles per second and 25,000 cycles per second.

44. The portable pipe cutter of claim 42, wherein the frame further comprises a first set of legs extending toward the motor and spaced apart from each other to form the recess to accommodate the bearing.)

45. The portable pipe cutter of claim 41, further comprising a housing that receives the cutting blade, wherein the housing includes a second set of legs extending away from the motor and spaced apart from each other more than the first set of legs such that the cutting blade is accommodated between the second set of legs.

46. The portable pipe cuter of claim 45, wherein the cutting blade is removably connected to the frame.

47. The portable pipe cutter of claim 41, wherein the cutting blade is concave.
